(19) United States
(12) Patent Application Publication
(10) Pub. No.: US 2015/0138597 A1
(43) Pub. Date: May 21, 2015

(54) MOBILE TERMINAL, IMAGE FORMING APPARATUS, CONTROL METHOD THEREOF, AND STORAGE MEDIUM STORING A PROGRAM

(71) Applicant: CANON KABUSHIKI KAISHA, Tokyo (JP)

(72) Inventor: Motoki Koshigaya, Kawasaki-shi (JP)

(21) Appl. No.: 14/540,303

(22) Filed: Nov. 13, 2014

(30) Foreign Application Priority Data
Nov. 20, 2013 (JP) 2013-240258

(51) Int. Cl. H04N 1/00; H04N 1/21; H04W 4/00

(52) U.S. Cl. CPC H04N 1/00973; H04W 4/008; H04N 1/00307; H04N 1/00132; H04N 1/00095; H04N 1/00856; H04N 1/21; H04N 1/0097; H04N 2201/0094
USPC 358/1.15

(57) ABSTRACT

Setting information of a function to be executed by a target device is set and stored in a mobile terminal including a contactless-type wireless communication unit, and when contactless-type wireless communication is established with the target device, the stored setting information is sent to the target device by the contactless-type wireless communication unit.

### BACKGROUND OF THE INVENTION

1. Field of the Invention

The present invention relates to mobile terminals, image forming apparatuses, control methods thereof, and storage media storing a program.

2. Description of the Related Art

In recent years, a technology called NFC (near field communication), which is one short distance wireless communication function, has been spreading rapidly in mobile terminals such as smartphones and tablet PCs. Three functions are stipulated in the NFC specification. The first is a reader/writer function, which enables execution of reading and writing data for NFC cards and NFC tags. The second is a peer-to-peer function, which enables the transceiving of various data via NFC. Through an action (hereinafter, “touch”) by a user of causing an NFC equipped mobile terminal to touch a target electronic device, data transmissions can be executed between two NFC equipped devices. Furthermore, there is no limitation to only NFC, and the mobile terminal may be provided with various near field communication functions such as WiFi and Bluetooth (registered trademark). For this reason, there is much interest in device cooperation by which new value is discovered through utilizing these functions between electronic devices. A cooperative technology for devices is known (Japanese Patent Laid-Open No. 2010-199642) as a technology of utilizing these features wherein display information of screens of a mobile terminal is sent to an image forming apparatus using near field communication, and wherein the image forming apparatus executes an operation associated with that display information.

Address-free office environments in which there is no fixed seating and working at transition destinations without remaining within one's own office have become common in business styles of recent years. Furthermore, among people who work by way of such a business style, there is a tendency to use high function mobile communication terminals such as smartphones and tablet PCs. Consequently, rather than merely image forming apparatuses that are fixed installations, it is anticipated that image forming apparatuses will be used in various locations. For this reason, in conventional methods in which display information and behavior history are referenced to decide an associated operation, it is necessary for the user to use an image forming apparatus in which the behavior history of that user is remaining. Consequently, since the aforementioned operations cannot be carried out on any image forming apparatus, the convenience required by the user is not satisfied.

### SUMMARY OF THE INVENTION

An aspect of the present invention is to eliminate the above-mentioned problems with the conventional technology.

The present invention provides a technology in which settings information of functions usually used by a user are registered in a mobile terminal, and by merely touching that mobile terminal to a target device, the settings information of that user are registered in the target device, thereby enabling usage.

The present invention in one aspect provides a mobile terminal including a contactless-type wireless communication unit, comprising: a setting unit configured to perform setting of setting information of a function to be executed by a target device, a storage unit configured to store the setting information set by the setting unit, and a control unit configured to perform control such that the setting information stored in the storage unit is sent to the target device by the contactless-type wireless communication unit.

According to the present invention, the user registers settings information of functions in a mobile terminal, and by merely bringing that mobile terminal close to a target device, settings information by which those functions are executed can be set in the desired device. In this way, the time and effort involved in inputting a user's desired settings information to a target device can be omitted even in a case where the user operates various devices.

Further features of the present invention will become apparent from the following description of exemplary embodiments with reference to the attached drawings.

### BRIEF DESCRIPTION OF THE DRAWINGS

FIG. 1 is a schematic diagram of an image forming system.

FIG. 2 is a block diagram showing a hardware configuration of a mobile terminal.

FIG. 3 is a block diagram showing a hardware configuration of an image forming apparatus.

FIG. 4 is a sequence diagram for describing a procedure for establishing communication when contactless wireless communication is carried out between a mobile terminal and an image forming apparatus.

FIG. 5 is a flowchart for describing processing by an image forming apparatus cooperative application that is executed by the mobile terminal.

FIGS. 6A to 6D are diagrams showing screen examples of the image forming apparatus cooperative application, which are displayed on a display unit of the mobile terminal.

FIG. 7 is a flowchart for describing processing in which the mobile terminal sends job settings information to the image forming apparatus using contactless wireless communication.

FIG. 8 is a flowchart for describing processing in which the image forming apparatus establishes contactless wireless communication and receives job settings information, then executes the job in accordance with the settings information.

FIG. 9 is a flowchart for describing processing when a function attribute of the settings information is determined to be for copying in FIG. 8.

FIG. 10 is a flowchart for describing processing in a case where the function attribute of the job settings information is for scanning to send in FIG. 8.

FIG. 11 is a flowchart showing processing in a case where the function attribute of the job settings information is for faxing to send in FIG. 8.

FIG. 12 is a sequence diagram for describing a series of procedures for establishing communication when contactless wireless communication is carried out between the mobile terminal and the image forming apparatus, and for carrying out a process in which a switch known as a handover is made to another wireless communication route.

FIG. 13 is a flowchart for describing processing in which, after the mobile terminal has obtained an IP address or security key using contactless wireless communication, a switch is made to near field communication and the job settings information is sent.

FIG. 14 is a flowchart for describing processing in which the image forming apparatus establishes contactless wireless communication and receives job settings information, then executes that job.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Same reference numbers are assigned to same compositional elements and description thereof is omitted.

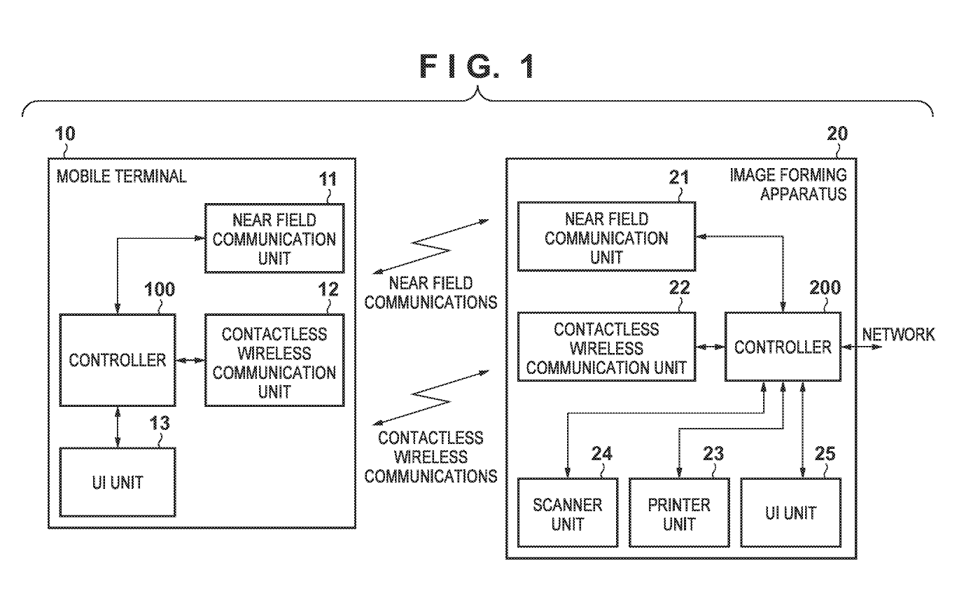

FIG. 1 is a schematic diagram of an image forming system according to embodiment 1 of the present invention.

The system according to embodiment 1 is provided with a mobile terminal 10 and an image forming apparatus 20. The mobile terminal 10 has a near field communication unit 11 and a contactless wireless communication unit 12 that performs communication at a closer distance than the near field communication unit 11. The image forming apparatus 20 also has a near field communication unit 21 and a contactless wireless communication unit 22 that performs communication at a closer distance than the near field communication unit 21.

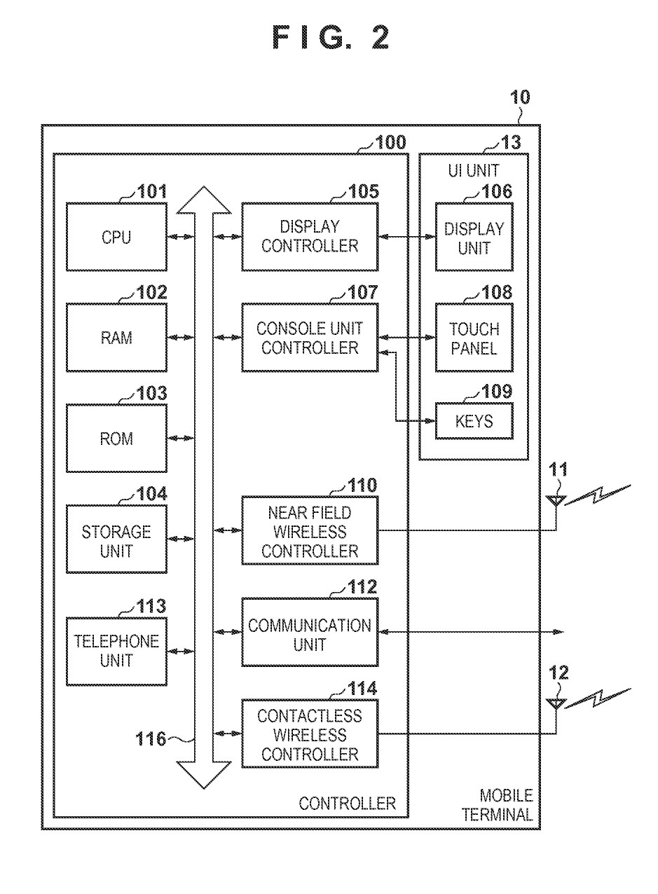

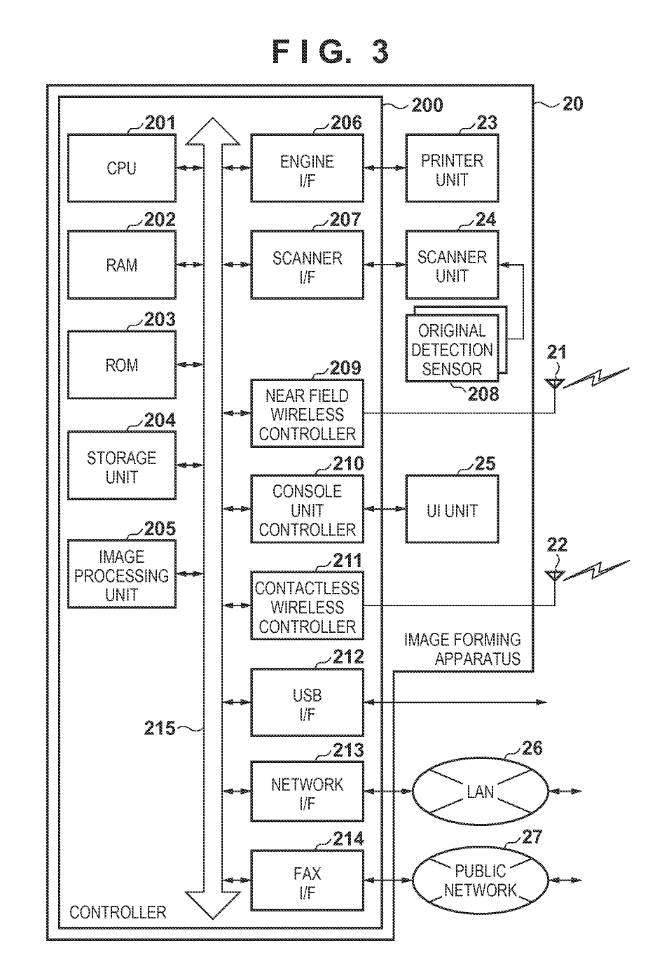

The mobile terminal 10 is a mobile phone such as a smartphone or the like, a tablet computer, a laptop computer, or a PDA or the like. A controller 100 of the mobile terminal 10 is electrically connected to the near field communication unit 11, the contactless wireless communication unit 12, and a UI unit 13, and administers control over each of these. The image forming apparatus 20 is an MFP (multifunction peripheral) provided with multiple functions. A controller 200 of the image forming apparatus 20 is electrically connected to the near field communication unit 21, the contactless wireless communication unit 22, a scanner unit 24, a printer unit 23, and a UI unit 25, and administers control over each of these. Details of the functions of these are described with reference to the block diagrams of FIG. 2 and FIG. 3, which show hardware configurations.

It should be noted that in the present embodiment, near field communication indicates wireless communication based on a communications standard such as Wi-Fi or Bluetooth (registered trademark) for example. Furthermore, contactless wireless communication (also called as “contactless-type wireless communication”) indicates wireless communication at a shorter distance than near field communication according to NFC cards/NFC tags, FeliCa, or MIFARE or the like. Communication is carried out using contactless wireless communication by causing two devices having contactless wireless communication means to approach or contact each other.

FIG. 2 is a block diagram showing a hardware configuration of the mobile terminal 10 according to embodiment 1.

The mobile terminal 10 has components such as the controller 100, a display unit 106 belonging to the UI unit 13, a touch panel 108, keys 109, the near field communication unit 11, and the contactless wireless communication unit 12, and the functions of the mobile terminal device 10 are achieved by these units working in cooperation with each other. A CPU 101 of the controller 100 is a central processing unit that controls the overall operations of the mobile terminal 10, and is connected to each of the units through a system bus 116. A RAM 102 provides a work memory when the CPU 101 performs operations, and stores computational data and various programs of the CPU 101. A ROM 103 contains cooperative applications that operate in cooperation with the image forming apparatus 20 such as programs executed by the CPU 101 of the mobile terminal 10. A storage unit 104 is a nonvolatile secondary storage unit for saving large sized programs and data and the like, and may be configured for example as a memory device of a standard such as an SD card or SSD, or may be one area of a region of the ROM 103. The large sized programs and data stored here are used by being expanded into the RAM 102. The display unit 106 carries out various types of display under the control of a display controller 105, while the touch panel 108 and the keys 109 are controlled by a console unit controller 107, and console operations are enabled through the cooperation of these components. A user performs operations on this UI unit 13, thereby enabling processing to be achieved, which is discussed later.

A near field wireless controller 110 is contained in the near field communication unit 11, and this carries out wireless communication at a close distance to an external device such as the image forming apparatus 10. For example, it is an interface of a wireless communication standard that carries out communication using Wi-Fi or Bluetooth (registered trademark). A communication unit 112 carries out communication through separate routes from the near field communication unit 11 and the contactless wireless communication unit 12. For example, it is a communication interface such as USB or an independent standard. Configurations are also possible in which the input-output functions of the UI unit 13 are supplemented by connecting externally attached input interface devices to the near field wireless controller 110 and the communication unit 112. A telephone unit 113 is connected to an unshown microphone and speaker and is configured so as to operate as a phone connected to a public network. A contactless wireless controller 114 is contained in the contactless wireless communication unit 12, and this carries out communication at a closer distance than the near field communication unit 11. For example, it is an interface of a standard in which communication is executed through performing a touch to a partner device such as NFC (reader/writer, tag) or the like. The contactless wireless communication unit 12 carries out transceiving of authentication data and IP addresses of users for logging into the image forming apparatus 20 and communication of setting information of functions to be executed on the image forming apparatus 20 according to the present embodiment 1.

FIG. 3 is a block diagram showing a hardware configuration of the image forming apparatus 20 according to embodiment 1. Furthermore, to facilitate description, a configuration of a portion of an external unit environment is also included.

The image forming apparatus 20 has the controller 200, the printer unit 23, the scanner unit 24, the UI unit 25, the near field communication unit 21, and the contactless wireless communication unit 22, and functions such as printing, scanning, copying, and faxing are achieved by these units working in cooperation with each other.

A CPU 201 of the controller 200 is a central processing unit that controls the overall operations of the image forming apparatus 20, and is connected to each of the units through a system bus 215. A RAM 202 provides a work memory when the CPU 201 executes processing, and stores computational data and various programs of the CPU 201. Furthermore, the RAM 202 may also be used as an image memory that holds image data on which various types of image processing have been implemented by an image processing unit 205 during printing or the like. The ROM 203 stores programs and settings data to be executed by the CPU 201 of the image forming apparatus 20. A storage unit 204 is a nonvolatile secondary storage device for saving large sized programs and data, and the large sized programs and data that are saved herein are expanded by the RAM 202 for use. The storage unit 204 may be configured for example as a memory device of a standard such as HDD or SSD, or may be one area of a region of the ROM 203.

The scanner unit 24 reads an original and outputs image data thereof. The printer unit 23 prints the image onto paper in accordance with print data. The UI unit 25 handles the display of various types of settings operations and alarms and the like. The scanner unit 24 includes an original detection sensor 208 that detects a presence/absence of an original. An original detection sensor 208 is provided in each of a pressing board unit (platen scanner unit) and an ADF unit (auto document feeding unit). In the case of the pressing board unit, when an original is placed onto the platen glass, the sensor detects this and notifies the scanner unit 24. In the case of the ADF unit, when an original is placed into the feeder, the sensor detects this and notifies the scanner unit 24. Upon receiving instructions from the controller 200 via a scanner I/F 207, the scanner unit 24 optically reads the original in accordance with the instructions, then converts the image of that original into image data and transmits this to the controller 200. Furthermore, upon receiving print data from the controller 200 via an engine I/F 206, the printer unit 23 commences feeding of a sheet and prints an image onto the fed sheet in accordance with the print data, then discharges the printed sheet. The UI unit 25 carries out communication with the controller 200 via a console unit controller 210. It should be noted that the console unit controller 210 may be included within the configuration of the UI unit 25. Communication with external units is carried out via a network I/F 213 and a fax I/F 214.

A near field wireless controller 209 is contained in the near field communication unit 21, and this carries out wireless communication at a close distance to an external device such as the mobile terminal. For example, it is an interface of a wireless communication standard that carries out communication using Wi-Fi or Bluetooth (registered trademark). A contactless wireless controller 211 is contained in the contactless wireless communication unit 22, and this carries out communication at a closer distance than the near field communication unit 21. For example, it is an interface of a standard in which communication is executed through performing a touch to a target device such as NFC (reader/writer, tag) or the like. A USB I/F 212 carries out USB communications in which an information device (hereinafter, PC) such as an unshown computer performs a local connection through a USB connector. The network I/F 213 connects to a LAN 26 via a LAN I/F connector and carries out communications with the PC or the like targeted for communication through the LAN 26. An unshown wireless LAN access point is also connected to the LAN 26, and communications with the mobile terminal 10 and the PC and the like are carried out by the near field communication unit 21 through this access point. The fax I/F 214 is connected to a public network 27 via a modular jack, and the sending and receiving of faxes are carried out with fax devices targeted for communication.

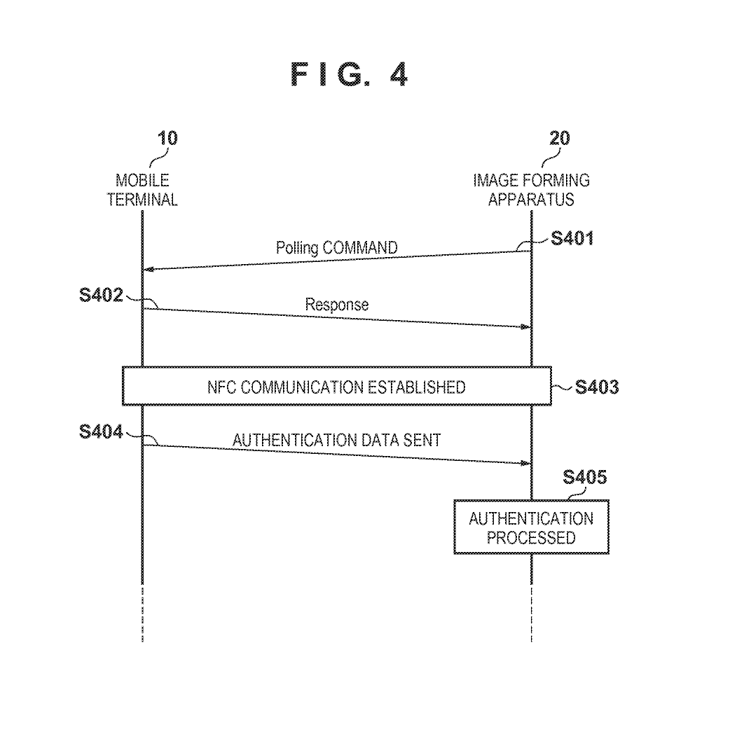

FIG. 4 is a sequence diagram for describing a procedure for establishing communication when contactless wireless communication is carried out between the mobile terminal 10 and the image forming apparatus 20 according to embodiment 1. Here, and for all the embodiments, communication using NFC is shown as an example of contactless wireless communication. NFC is a near field communication standard that uses electromagnetic waves of 13.56 MHz, and enables bi-directional communication between devices while maintaining a mutual connection with an existing contactless IC card.

A connection commences when a user brings a mobile terminal 10 close to the contactless wireless communication unit 22 of the image forming apparatus 20. Here, in a case where both the contactless wireless communication unit 12 of the mobile terminal 10 and the contactless wireless communication unit 22 of the image forming apparatus 20 are NFC readers/writers, a Poll mode in which a command can be sent and a Listen mode in which a command can be received are repeated alternately at an arbitrary interval. In this way, communication is established between two devices in a case where one is in Poll mode and the other in Listen mode. In the present embodiment 1, it is assumed that settings of functions to be executed on the image forming apparatus 20 are carried out even when applications are not running on the mobile terminal 10. For this reason, in the present embodiment 1, description is given of an example of an NFC connection when the mobile terminal 10 is in Listen mode and the image forming apparatus 20 has been activated in Poll mode. The reverse may occur depending on the timing of the connection, but description is omitted since this is the case after connecting. Furthermore, in the case of a low-end image forming apparatus 20 in which costs are suppressed, an NFC tag may be substituted rather than the contactless wireless communication unit 22 being an NFC reader/writer. Description of this instance is given in embodiment 2.

First, at S401, the contactless wireless communication unit 22 of the image forming apparatus 20 sends a Polling command to the contactless wireless communication unit 12 of the mobile terminal 10. Next, at S402, the contactless wireless communication unit 12 of the mobile terminal 10 gives a response of technology, which is the specification corresponding to the wireless interface of Type A, Type B, or FeliCa. In this manner, NFC communication is established at S403. This is a basic flow of NFC connections up to this point. The implementation up to this point is also acceptable, but description will proceed hereon by combining a standard authentication function to the image forming apparatus 20.

Next, at S404, the contactless wireless communication unit 12 of the mobile terminal 10 sends authentication data for logging into the image forming apparatus 20. At this time, a configuration is also possible in which, along with the authentication data, job setting information is also appended simultaneously, which is described later. The authentication data includes the unique Mac address of the mobile terminal 10 and IDs or the like saved in a dedicated NFC storage area. Upon receiving this authentication data, the CPU 201 of the image forming apparatus 20 sends the authentication data to an unshown management server to carry out authentication. Alternatively, in a case where authentication is carried out locally inside the device of the image forming apparatus 20, the authentication data is received then temporarily held in the RAM 202. When authentication is carried out by an external management server, the user data managed by the external unshown management server and the authentication data that has been sent are compared. Furthermore, similarly, when authentication is carried out by the image forming apparatus 20, a comparison is performed (S405) with the authentication data held in the RAM 202 according to an authentication program based on management data stored in the ROM 203 or storage unit 204. Here, in a case where authentication fails, a display is given on the UI unit 25 of the image forming apparatus 20 that notifies of the authentication error. Up to this point were the steps for the completion of authentication.

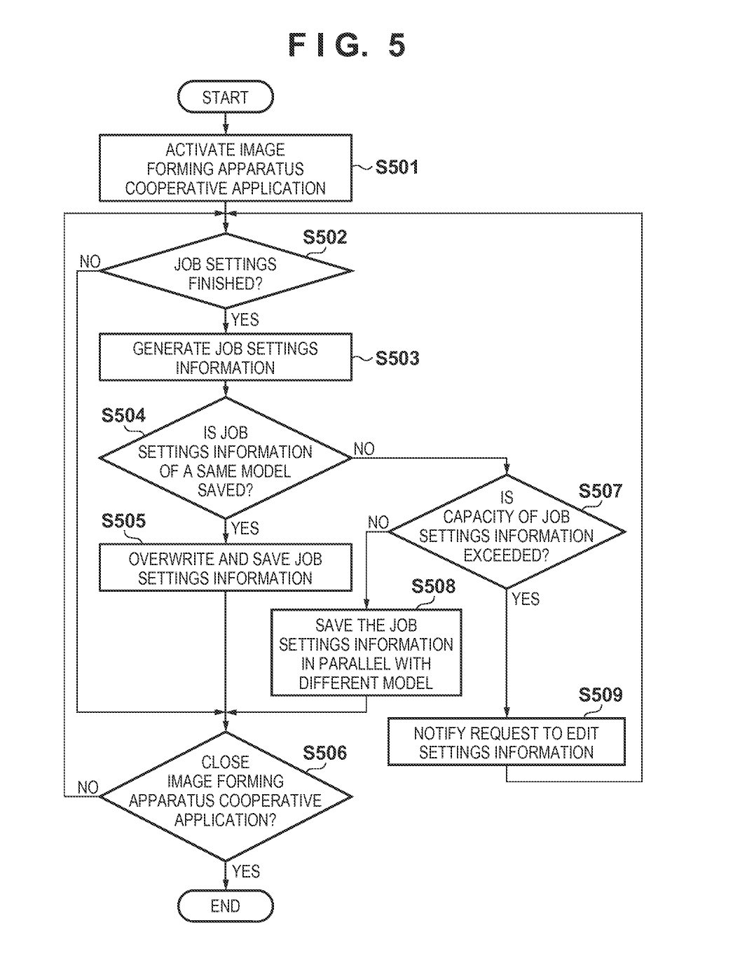

FIG. 5 is a flowchart for describing processing by an image forming apparatus cooperative application that is executed by the mobile terminal 10 according to embodiment 1. The processing indicated in this flowchart is executed by the CPU 101, which expands into the RAM 102 a program stored in the ROM 103 of the controller 100 of the mobile terminal 10 or in the storage unit 104, then executes the program. In embodiment 1, the application that is executed here is referred to as an image forming apparatus cooperative application.

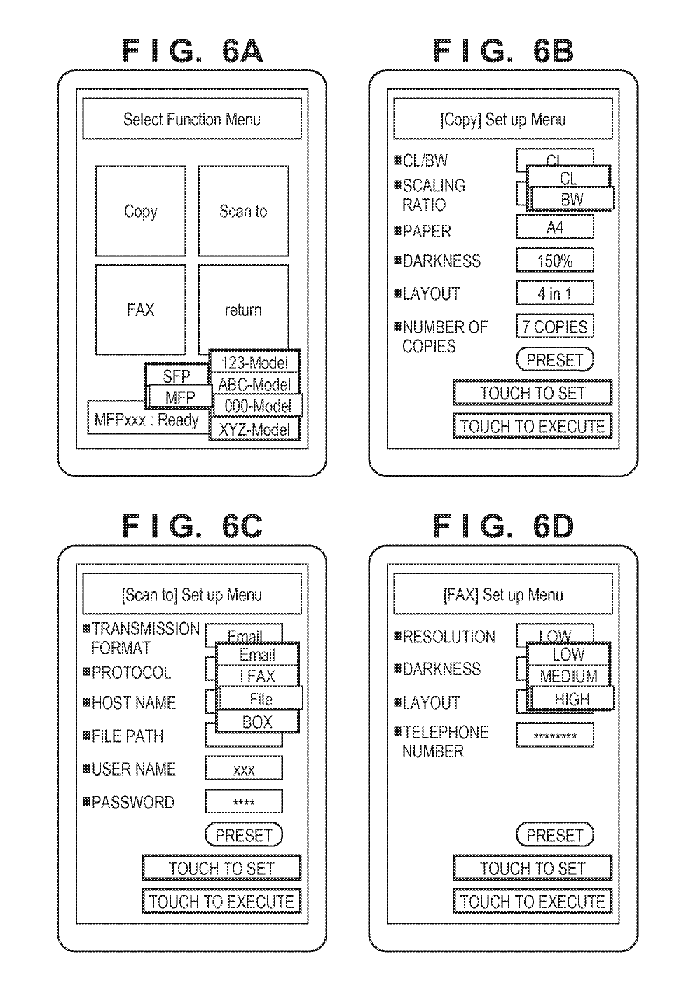

Furthermore, FIGS. 6A to 6D are diagrams showing screen examples of the image forming apparatus cooperative application, which are displayed on the display unit 106 of the mobile terminal 10 according to embodiment 1.

First, at S501, the CPU 101 activates the image forming apparatus cooperative application. Once the image forming apparatus cooperative application is activated, the CPU 101 prompts the user to select a model (type). At this time, by selecting the model in the application, items that cannot be set automatically are masked. This is because items that can be set are limited according to model. After this, a selection is prompted of the functions desired to be set of the model type selected by the user. FIG. 6A shows a screen display of this time.

FIG. 6A shows a situation in which “000-Model” has been selected from among MFP model types. Furthermore, “copy,” “fax,” and “scan to” and the like are displayed as menu items for selection.

FIGS. 6B to 6D show example screens of detailed settings when copy, scan to, and fax have been selected respectively on the screen of FIG. 6A.

For example, when the user sets monochrome (BW), scaling ratio, paper size, darkness, layout or number of copies and presses “touch to set” or “touch to execute” on the copy settings screen of FIG. 6B, the setting of the information of these settings is completed.

At S502, the CPU 101 determines whether or not the user has completed the job settings, and if this is not the case, the procedure proceeds to S506, but proceeds to S503 when the job settings are completed. At step S503, the CPU 101 generates job setting information. Here, the setting information of the job to be generated is in a format that can be determined when received by the image forming apparatus 20, and is generated as follows. First, an attribute is assigned for the type of model. Following this, when copy has been selected for example, color (monochrome/color), scaling ratio, paper, darkness, layout, and number of copies are to be specified.

Furthermore, when scan to has been selected as shown in FIG. 6C, a transmission method, a protocol (email format, I-Fax format, file sending format, or a format for saving to storage), a host name, a file path, and user name and the like are to be set.

Furthermore, when the fax function of FIG. 6D has been selected, settings such as those for resolution, darkness, layout, addressee phone number and the like are to be set. Furthermore, so that authentication for using the image forming apparatus 20 can be achieved in a one-time data transmission, unique ID information (identification information) of the mobile terminal 10 is also included together and generated. Furthermore, in a case where the address when sending a file is a publicly open server such as for a webDAV or SMB protocol, login information (ID, password, or Authorize information) is also included for accessing these.

Further still, when the sending of the job settings information has been completed, the “touch to execute” button in FIGS. 6B to 6D is a software key for giving instruction for the image forming apparatus 20 to immediately execute a function based on the settings information. And the “touch to set” button is a software key for sending only the settings information to the image forming apparatus 20 and allowing the user to perform the final execution by operating the image forming apparatus 20. These sets of information are generated as settings information of a single job. A “preset” button is for retrieving settings information in a case where settings information has been preset in advance. Settings information that has been preset is saved in the ROM 103 or the storage unit 104 of the mobile terminal 10. Furthermore, a configuration is also conceivable in which the settings of another model are imported to the settings of an again different model.

When the generation of job settings information finishes at S503 in this manner, the procedure proceeds to S504 and the CPU 101 determines whether or not job settings information is already saved of a same model as the job settings information that is about to be saved. Here, a location where job settings information is to be stored is a dedicated storage area that is read out when contactless communication has been established with the image forming apparatus 20. The storage area in which job settings information is saved is for example the ROM 103 or the storage unit 104 of the mobile terminal 10, or a ROM area held by the contactless wireless controller 114.

At S504, the procedure proceeds to S505 when the CPU 101 determines that same model job settings information is present in the storage area in which job settings information is stored, and the same model job settings information is overwritten by the settings information that is generated at S503 and saved. This is for executing only one desired job when job settings have been performed by touching the mobile terminal 10 to the image forming apparatus 20. After this, the procedure proceeds to S506 and the CPU 101 determines whether or not the closing of the image forming apparatus cooperative application has been instructed, and when closure has been instructed, the flow of saving job settings information finishes. When there is no instruction to close here and there is a continuation of settings information to be set, the procedure proceeds to S502 and a selection of job settings commences from the settings screen.

On the other hand, the procedure proceeds to S507 when the CPU 101 determines at S504 that there is no same model job settings information in the storage area in which job settings information is stored, and the CPU 101 determines whether or not the capacity of the storage area will be exceeded if the job settings information is saved. In contactless communication, communication is completed in one moment of physical sensation such as a touch, and therefore not very large amounts of data can be handled. For this reason, a check is carried out of the data capacity. In regard to a capacity threshold, this may be decided arbitrarily in implementation since this also depends on communication speeds and storage device capacities. When the CPU 101 determines at S507 that there is no problem for the capacity of the storage area even if new job settings information is saved, the procedure proceeds to S508 and the CPU 101 saves the settings information in parallel in response to the model of the image forming apparatus and the procedure proceeds to S506. This is so that the settings information of multiple models can be sent simultaneously when contactless communication has been established with the image forming apparatus 20, which is discussed later. In this way, even in a situation where the image forming apparatus cooperative application is not running, settings can be performed in accordance with the settings information by merely touching the preset job settings with various models of image forming apparatuses 20.

Furthermore, when the CPU 101 determines at S507 that the storage area capacity will be exceeded if the new job settings information is saved, the procedure proceeds to S509 and the CPU 101 displays a screen notifying for the user to reedit the job settings information. Upon receiving this, the user again returns to the screen at which settings are performed of job settings information, and carries out a deletion of settings information or re-input of settings.

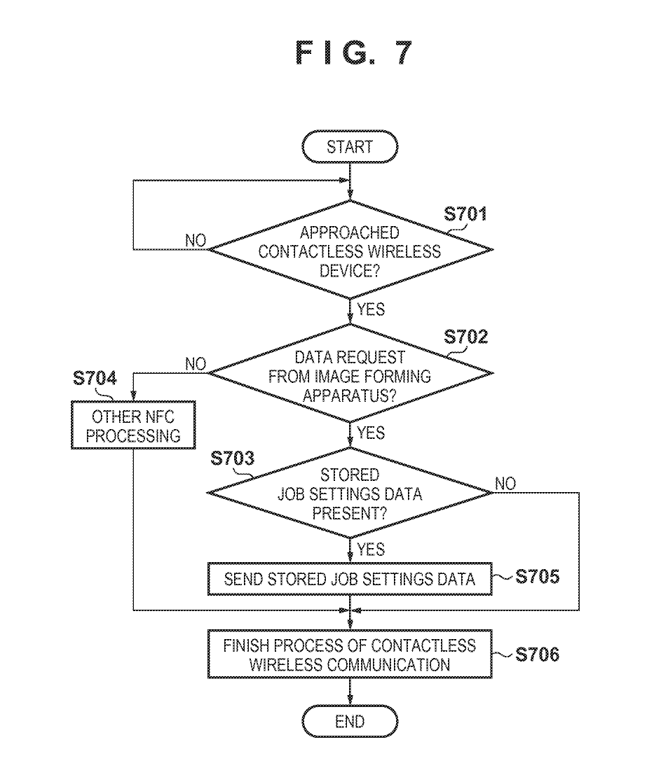

FIG. 7 is a flowchart for describing processing in which the mobile terminal 10 according to embodiment 1 sends job settings information to the image forming apparatus 20 using contactless wireless communication. The processing indicated in this flowchart is achieved by the CPU 101 expanding into the RAM 102 a program stored in the ROM 103 or the storage unit 104 of the mobile terminal 10, then executing the program.

First, at S701, the CPU 101 determines whether or not the mobile terminal 10 has approached an image forming apparatus that supports contactless wireless communication, that is, whether or not it has been touched to the image forming apparatus. When it is determined that an approach has occurred, the procedure proceeds to S702 and the CPU 101 carries out contactless wireless communication with that image forming apparatus. In embodiment 1, the contactless wireless communication is assumed to be NFC communication. The establishment of NFC communication is as described in FIG. 4, and the procedure proceeds to the processing of S702 when the processing up to S403 or S405 of FIG. 4 has finished. At S702, the CPU 101 determines whether or not there is a data request from the image forming apparatus 20, and if there is, the procedure proceeds to the processing at S703. On the other hand, the procedure proceeds to S704 when there is no data request from the image forming apparatus 20, and NFC communication corresponding to the partner device is executed, but description of this is omitted here.

At S703, the CPU 101, which has received a data request from the image forming apparatus 20 after NFC communication has been established with the image forming apparatus 20, determines whether or not there is job settings information that has been saved according to the procedure of FIG. 5 in the aforementioned storage area. At S703, when the CPU 101 determines that there is job settings information in the storage area, the procedure proceeds to S705, and the CPU 101 sends the job settings information that is stored in the storage area to the image forming apparatus 20 via the contactless wireless communication unit 12. After this, the procedure proceeds to S706, and the CPU 101 carries out an NFC communication finishing process, thereby finishing this process. Furthermore, when the CPU 101 determines at S703 that there is no job settings information in the storage area, the procedure proceeds to S706 and an NFC communication finishing process is carried out, thereby finishing this process.

Through the above-described process, settings information for copying, scan to send, and faxing for example is registered in advance in the mobile terminal 10, such that the registered settings information can be sent and set in the image forming apparatus merely by bringing the mobile terminal close to the image forming apparatus, which is a target device. In this way, when the user is to use an image forming apparatus in a variety of locations, the user can use the image forming apparatus simply by setting the desired settings information therein.

Furthermore, the image forming apparatus cooperative application is configured such that even if the user inadvertently touches the mobile terminal to a device other than a target device, the settings information is not set therein and settings information is not sent to devices other than target devices. For this reason a configuration is used in which, in a case where contactless wireless communication has been established with a non-target device image forming apparatus, access is not enabled to the storage area where the settings information is saved. It should be noted that in regard to whether or not a device is a target device, this may be determined for example by whether or not its model name is in agreement as shown in FIG. 6A.

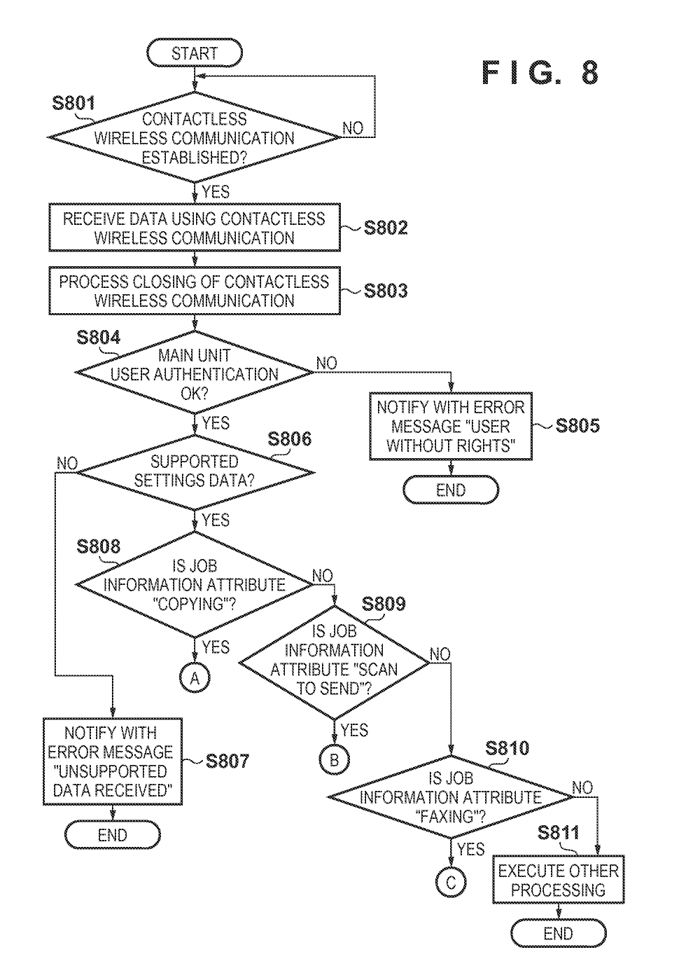

FIG. 8 to FIG. 11 are flowcharts for describing processing in which the image forming apparatus 20 according to embodiment 1 establishes contactless wireless communication and receives job settings information, then executes the job in accordance with the settings information. The processing indicated in these flowcharts is achieved by having the CPU 201 expand a program stored in the ROM 203 or in the storage unit 204 of the controller 200 of the image forming apparatus 20 into the RAM 202, then executing the program. Here also, as in the description of the processing by the mobile terminal 10, the contactless wireless communication is assumed to be NFC communication. The establishment of NFC communication is as described in FIG. 4.

First, at S801, the CPU 201 determines whether or not contactless wireless communication has been established with the mobile terminal 10. Here, when the state of S403 of the foregoing FIG. 4 is achieved, the procedure next proceeds to S802. At S802, the CPU 201 receives the data that has been sent due to the touch of the mobile terminal 10 to the image forming apparatus 20 in a same manner as S404 in FIG. 4. Here, data sent from the mobile terminal 10 is received via the contactless wireless communication unit 22 and the contactless wireless controller 211, and stored in the RAM 202. Next, the procedure proceeds to S803 and the CPU 201 carries out a process of closing NFC communication when the reception of data has finished, thereby deactivating the NFC connection. Next, the procedure proceeds to S804 and the CPU 201 carries out an authentication process in a same manner as S405 of FIG. 4. Processing in regard to this authentication is omitted here, see the description of FIG. 4. At S804, the CPU 201 proceeds to S805 when there is a failure in the authentication of whether or not the user can use the image forming apparatus 20, and an error is displayed on the UI unit 25 indicating that the user does not have usage rights, thereby finishing this process. In regard to this error display, there is no limitation to implementing this configuration, and may be an LED based error lamp lighting up, or the display of an error code or a message with an error description on the display device of the UI unit 25.

On the other hand, the procedure proceeds to S806 when it is determined at S804 that there has been success in the authentication of a user allowed to use the image forming apparatus 20, and the CPU 201 determines whether or not the received data is job settings information supported by the image forming apparatus 20. The procedure proceeds to S807 when the CPU 201 has determined at S806 that the received job settings information is not supported, and an error is displayed on the UI unit 25 indicating that the data is not supported, thereby finishing this process. In regard to this error display, there is no limitation to implementing this configuration, and may be an LED based error lamp lighting up, or the display of an error code or a message with an error description on the UI unit 25. It is assumed here that the error is mainly errors caused by settings of different models since basically it is data generated for the image forming apparatus 20 to obtain.

In a case where the CPU 201 determines at S806 that the received data is settings information of a supported job, the procedure proceeds to S808, then it is determined at S808, S809, and S810 which functions are to be executed for the attributes of the settings information, and processing corresponding to these respectively is executed.

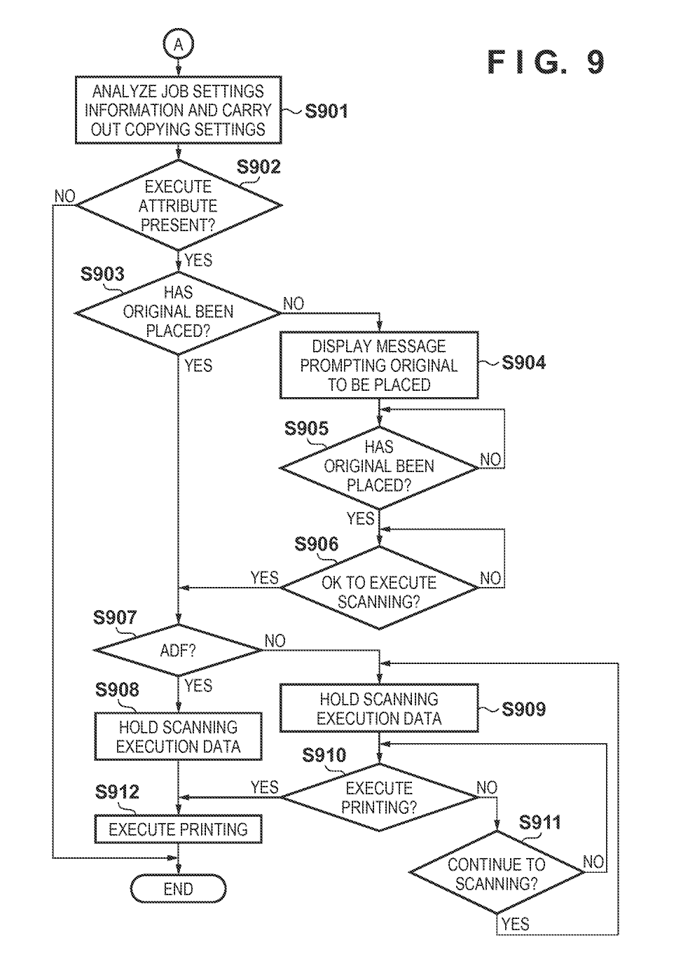

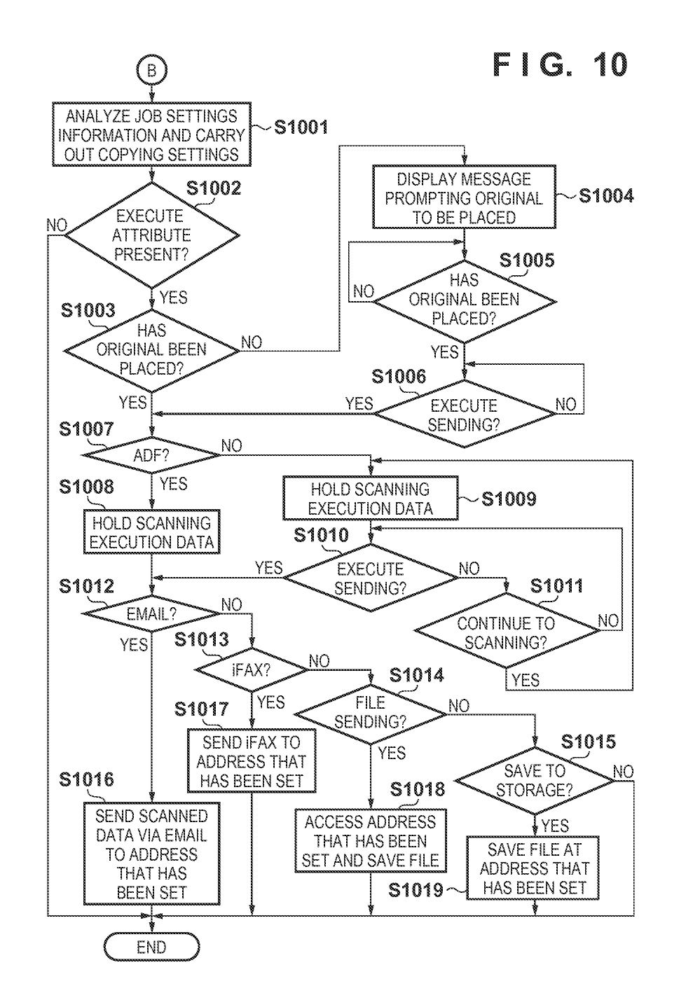

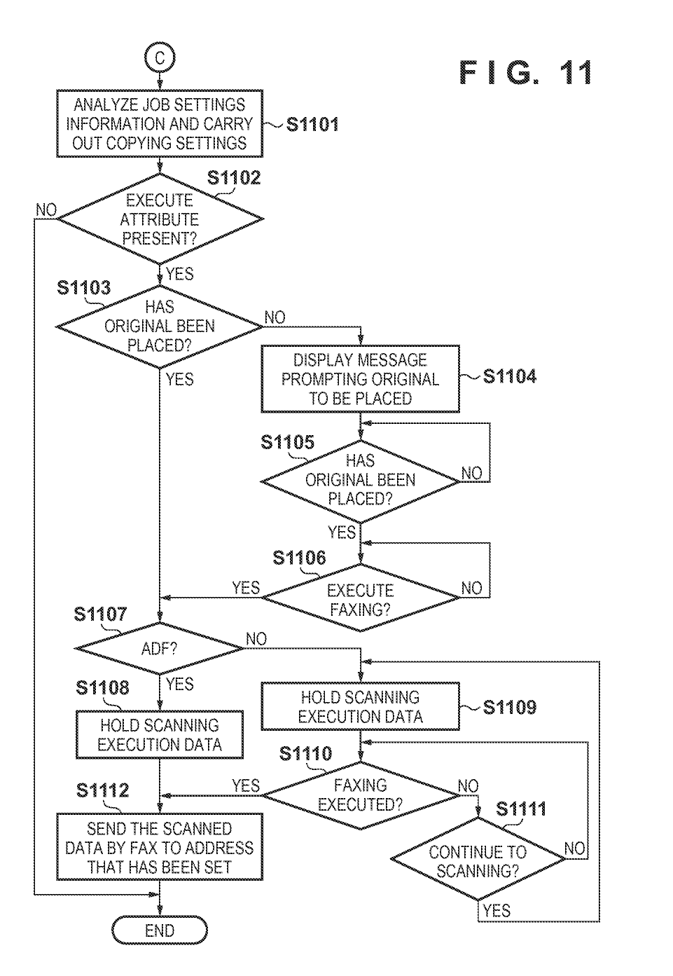

At S808 the CPU 201 determines whether or not the function attributes of the job settings information is for copying, and if it is, processing proceeds to S901 of FIG. 9. If it is not copying, then processing proceeds to S809. When scan to send is determined at S809, processing proceeds to S1001 of FIG. 10. If it is not scan to send, then processing proceeds to S810. When faxing is determined at S810, processing proceeds to S1101 of FIG. 11. For cases other than these, processing proceeds to S811 and other settings processing is carried out. In regard to other settings processing, these are anticipated to be IP address settings, WiFi handovers and the like. A configuration may also be applied in which settings for shipping from the factory are implemented collectively. After executing other processing such as settings changes, this process finishes.

FIG. 9 is a flowchart for describing processing when a function attribute of the settings information is determined to be for copying.

At S901, the CPU 201 analyzes the job settings information received in accordance with the flowchart of FIG. 8, and overwrites the copying settings in accordance with the settings information. On the display of the UI unit 25 of the image forming apparatus 20 at this time is displayed a screen of the copying function that has been set here. Next, the procedure proceeds to S902 and the CPU 201 determines whether or not there is an attribute for immediate execution in the job settings information. This “execute immediately attribute” is set in a case where the “touch to execute” button is pressed on the screen of FIG. 6B for example. When it is determined at S902 that there is no attribute for immediate execution, this process finishes by merely setting the settings information at S901.

On the other hand, when the CPU 201 determines at S902 that there is an attribute for immediate execution in the job settings information, processing proceeds to S903 and the CPU 201 determines whether or not an original is placed in the scanner unit 24. The determination of whether or not an original has been placed is determined by the CPU 201 receiving a signal from the original detection sensor 208 through the scanner I/F 207. The procedure proceeds to S907 in a case where the CPU 201 determines at S903 that an original has been placed, and proceeds to S904 in a case where it is determined that an original has not been placed. At S904, since copying cannot be executed in the current state, the CPU 201 carries out a display on the UI unit 25 prompting the user to place an original. Here, in a case where the UI unit 25 does not include a display device, a substitute process such as lighting up an LED based “no paper” notification may be used. At S905, the CPU 201 stands by until an original is placed in the scanner unit 24, then proceeds to S906 when the original has been placed. At S906, the CPU 201 waits for an instruction from the user to commence execution of copying. Here the procedure proceeds to S907 when the user indicates commencement of copying by pressing a start button (not shown in diagram) on the UI unit 25.

At S907, the CPU 201 determines whether the original detection is from the ADF or from the pressing board unit, and carries out a branching for changing the subsequent processing. In a case where the original detection was ADF, the procedure proceeds to S908 and the CPU 201 instructs an original scanning. At this time the CPU 201 carries out an execution instruction for scanning in the scanner unit 24 via the scanner I/F 207, and receives image data of the original from the scanner unit 24 via the scanner I/F 207. The thus-received image data is stored temporarily in the RAM 203, after which the image processing unit 205 executes image processing on the image data and converts it to data for printing. Then the procedure proceeds to S912 and the CPU 201 outputs the data to the printer unit 23 for printing. In this print processing, the CPU 201 sends the data that has been expanded in the RAM 202 to the printer unit 23 via the engine I/F 206.

On the other hand, when the CPU 201 determines at S907 that the original detection is not ADF, but rather the pressing board unit, processing proceeds to S909. At S909 the CPU 201 executes the scanning of the original and saves the image data in the RAM 202. However, without immediately commencing printing thereafter, processing proceeds to S911 for determining whether or not there is a next original to be read. At S910, the CPU 201 waits for an instruction from the user to commence copying. Here, the procedure proceeds to S912 when there is a commencement instruction, and print processing is executed. However, when there is no print commencement instruction at S910, the procedure proceeds to S911 and the CPU 201 determines whether or not an instruction has been given for a continuation of scanning by switching in a next original. The procedure proceeds to S909 when scanning is instructed, and proceeds to S910 when there is no instruction for scanning. When the procedure proceeds to S909 the CPU 201 rescans then processes and saves the read image data in a same manner as the foregoing case. This is then repeated until commencement of printing is instructed. Thus, when scanning is completed of a number of originals desired by the user, the user carries out a print commencement instruction, thereby transitioning the procedure to S912 such that print processing is executed.

The foregoing is description of processing when it is determined that the function attribute of the job settings information received from the mobile terminal 10 is for copying. It should be noted that in the copying process, image processing and layout processing, as well as settings for number of copies and the like are carried out in accordance with the settings information received from the mobile terminal 10 when reading an original with the scanner unit 24 and when print processing with the printer unit 23.

FIG. 10 is a flowchart for describing processing in a case where the function attribute of the job settings information is for scanning to send.

At S1001, the CPU 201 analyzes the received job settings information, and overwrites the scan to send settings in accordance with the settings information. On the display device of the UI unit 25 of the image forming apparatus 20 at this time is displayed a screen including the scan to send function that has been set here. Next, the procedure proceeds to S1002 and the CPU 201 determines whether or not there is an attribute for immediate execution in the job settings information. In a case where in the CPU 201 determines at S1002 that there is no attribute for immediate execution, this process finishes in the current state as set at S1001. The processing of S1002 is the same processing of S902 in the foregoing FIG. 9.

In a case where the CPU 201 has determined at S1002 that there is an attribute for immediate execution in the job settings information, processing proceeds to S1003 and the CPU 201 determines whether or not an original is placed in the scanner unit 24. This determination is the same as S903 in FIG. 9. In a case where the CPU 201 determines at S1003 that an original has been placed, the procedure transitions to S1007. On the other hand, in a case where the CPU 201 determines at S1003 that an original has not been placed, then the procedure proceeds to S1004 and a message is displayed on the UI unit 25 prompting the user to place an original. Hereinafter, the processing in S1004 to S1006 in which the user is caused to place an original is the same as S904 to S906 in the foregoing FIG. 9, and therefore description thereof is omitted. Furthermore, the processing of S1007 to S1011 in which the ADF original is detected and the original placed on the pressing board unit is scanned is the same as S907 to S911 in FIG. 9, and therefore description thereof is omitted. When preparation for executing a scan to send is arranged according to the foregoing operations, the procedure transitions to the steps from S1012 onward.

At S1012, S1013, S1014, and S1015, a branching of processing is carried out according to the transmission protocol of the scan to send (email format, I-FAX format, file sending format, save to storage format). At S1012 the CPU 201 determines whether or not the sending is to be in email format, and if it is email format, then the procedure proceeds to S1016. At S1016, the CPU 201 converts the image data obtained through scanning to a format in the job settings information (PDF, JPEG, TIFF, XPS or the like) at the image processing unit 205. Then, it sends the converted image data as an attachment file email via the network I/F 213 to the address (email address or the like) contained in the job settings information, then this process finishes.

On the other hand, when the CPU 201 determines at S1012 that it is not email format, then the procedure proceeds to S1013 and the CPU 201 determines whether or not the sending is to be an I-FAX, and if it is, then the procedure proceeds to S1017. At S1017, the CPU 201 sends as an I-FAX the image data obtained through scanning to the address contained in the job settings information, then this process finishes.

Furthermore, when the CPU 201 determines at S1013 that it is not an I-FAX, then the procedure proceeds to S1014 and the CPU 201 determines whether or not the sending is to be a file sending format. If it is, the procedure proceeds to S1018, and the image data obtained through scanning is converted in the image processing unit 205 to a format contained in the job settings information (PDF, JPEG, TIFF, XPS or the like). Then, access is made to a location of an address (file path, URL, IP address or the like) and the converted image data is stored. In a case where the address at this time is a publicly open server such as a webDAV or SMB protocol, then login information (ID, password, or Authorize information) for achieving access to these is also set and accessed for storage, then this process finishes.

Furthermore, when it is not a file sending format at S1014, then the procedure proceeds to S1015 and the CPU 201 determines whether or not it is a save to storage format. If it is, then the procedure proceeds to S1019, but if it isn't, then processing finishes. At S1019, the CPU 201 converts the image data obtained through scanning to a format contained in the job settings information (PDF, JPEG, TIFF, XPS or the like) at the image processing unit 205. Then, access is made to a location of an address (file path, URL, IP address or the like) and the converted image data is stored there, thereby finishing this process.

The foregoing was a processing flow for a case where the function attribute of the job settings information received from the mobile terminal 10 is for scanning to send.

FIG. 11 is a flowchart showing processing in a case where the function attribute of the job settings information is for faxing to send.

At S1101, the CPU 201 analyzes the received job settings information, and overwrites the fax settings in accordance with the settings information. On the display device of the UI unit 25 of the image forming apparatus 20 is displayed a screen of the scan to send function in accordance with the settings information that has been set here. Following this, the procedure proceeds to S1102 and the CPU 201 determines whether or not there is an attribute for immediate execution in the job settings information in a same manner as S902 of FIG. 9. In a case where in the CPU 201 determines at S1102 that there is no attribute for immediate execution, this process finishes in the current state as set at S1101.

On the other hand, in a case where the CPU 201 has determined at S1102 that there is an attribute for immediate execution in the job settings information, the procedure proceeds to S1103 and the CPU 201 determines whether or not an original is placed in the scanner unit 24 in a same manner as S903 in FIG. 9. The determination of whether or not an original is placed is the same as described for FIG. 9. In a case where it is determined at S1103 that an original has been placed, the procedure transitions to S1107. In a case where it is determined at S1103 that an original has not been placed, then the procedure proceeds to S1104 and a scan to send cannot be executed, and therefore a screen is displayed on the UI unit 25 prompting the user to place an original. Hereinafter, the processing in S1104 to S1106 in which the user is caused to place an original is the same as S904 to S906 in FIG. 9, and therefore description thereof is omitted. Furthermore, the processing of S1107 to S1109 in which the ADF original is detected and the original placed on the pressing board unit is scanned is the same as S907 to S909 in FIG. 9, and therefore description thereof is omitted. The procedure proceeds to S1108 when an original is placed in the ADF at S1107, and the original is scanned by the scanner unit 24, with the image data thereof being stored, and the procedure proceeds to S1112. Furthermore, at S1110, the CPU 201 determines whether or not instruction has been given for sending a fax, and the procedure proceeds to S1112 when this has been instructed. At S1112, the CPU 201 converts the image data obtained through scanning at the image processing unit 205 to a format for sending a fax in accordance with the job settings information. Then, it sends the converted image data through the fax I/F 214 to the address (phone number) contained in the job settings information.

The foregoing was a processing flow for a case where the function attribute of the job settings information received from the mobile terminal 10 is for faxing to send.

According to the above-described embodiment 1, settings information of a job that have been set in advance are stored in advance by an image forming apparatus cooperative application in a storage area of the mobile terminal 10. Then, by touching the mobile terminal 10 to a target image forming apparatus, the settings information is set in the image forming apparatus and the execution of that job can be instructed to that image forming apparatus.

Furthermore, by storing job settings information for multiple types of image forming apparatuses in the storage area of the mobile terminal 10, it is possible to execute the job by setting the settings information in an image forming apparatus, even when the user is not at his own office and the image forming apparatus is at a transition destination.

In this way, according to embodiment 1, the user holds and carries a mobile terminal in which is registered the settings information of functions desired to be executed on a target device, then by merely touching this to the image forming apparatus, the desired settings information is set into that image forming apparatus, and it is possible to execute the desired function.

### Embodiment 2

Next, description is given regarding embodiment 2 according to the present invention. It should be noted that the configurations of the mobile terminal 10 and the image forming apparatus 20 according to embodiment 2 are the same as the foregoing embodiment 1, and therefore description thereof is omitted.

In embodiment 2, description is given of a case where a contactless wireless communication unit constituted by a contactless wireless controller 211 and a contactless wireless communication unit 22 of the image forming apparatus 20 is configured such that rather than NFC reader/writer, NFC tags are overwritten.

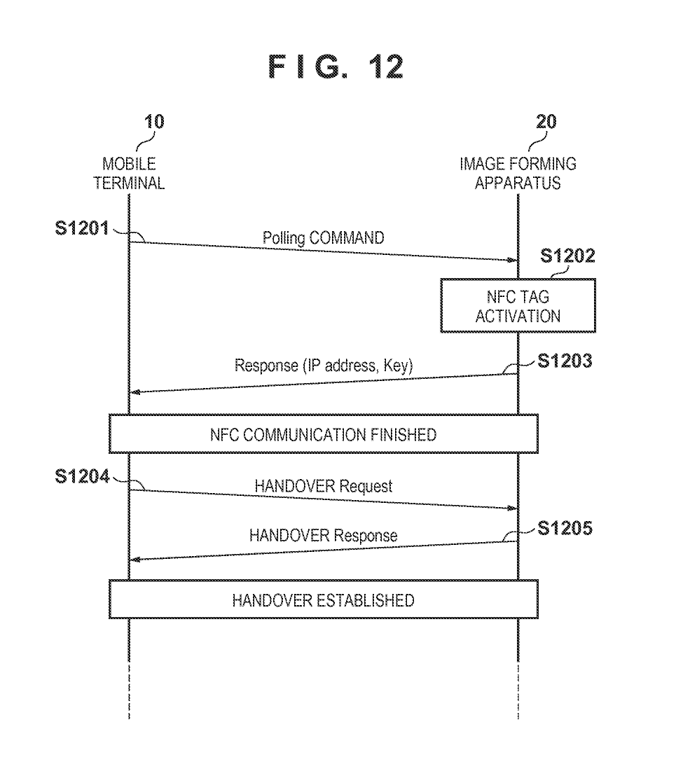

FIG. 12 is a sequence diagram for describing a series of procedures for establishing communication when contactless wireless communication is carried out between the mobile terminal 10 and the image forming apparatus 20 according to embodiment 2, and for carrying out a process in which a switch known as a handover is made to another wireless communication route. Here, an example is shown of when the contactless wireless communication unit of the above-described image forming apparatus 20 is an NFC tag. The contactless wireless communication unit 114 of the mobile terminal 10 is an NFC reader/writer in a same manner as in embodiment 1. A method known as a static handover is used in which a connection is performed by reading out settings information stored in advance in an NFC tag from the mobile terminal 10.

At S1201, converse to the description of FIG. 4, the contactless wireless communication unit 12 of the mobile terminal 10 sends a Polling command to the contactless wireless communication unit 22 of the image forming apparatus 20. Next, at S1202, since the contactless wireless communication unit 22 of the image forming apparatus 20 is an NFC tag, it does not actively emit a radio wave. Thus, the NFC tag is activated by a radio wave produced by the mobile terminal 10. Then, at S1203, the image forming apparatus 20 sends data of a response by causing the load inside the NFC tag to fluctuate. An IP address or security key of the storage area held in the NFC tag to be used in the handover is sent at this time. With the foregoing step, the obtaining of an IP address for the mobile terminal 10 to access the image forming apparatus 20 is finished through NFC communication.

In this manner, the mobile terminal 10, which has obtained the IP address or security key of the image forming apparatus 20, stores this information temporarily in the RAM 102 or the like. Next, a Wi-Fi communication connection is carried out via the near field communication unit 11. At S1204, the near field communication controller 110 of the mobile terminal 10 uses the IP address or security key stored recently in the RAM 102 to carry out a handover request to the image forming apparatus 20 via the near field communication unit 11. Next, at S1205, the near field communication controller 209 carries out authentication processing by detecting for a connection request from the mobile terminal 10 through the near field communication unit 21 of the image forming apparatus 20.

The foregoing is a control procedure for a handover process in embodiment 2 using NFC communication. For convenience, this handover process is carried out by having the mobile terminal 10 touch the image forming apparatus 20, but if the IP address or security key is known to the user, the mobile terminal 10 may be operated to perform the settings manually.

Next, description is given of a process of the mobile terminal 10 according to embodiment 2.

Basically, this is a process in which data that was sent by NFC switching to being sent by Wi-Fi. Accordingly, although the route of the process may change, areas where the description is equivalent are omitted. First, description of processing up to storing the job settings information using the image forming apparatus cooperative application is omitted since this is the same as the foregoing FIG. 5 and FIG. 6.

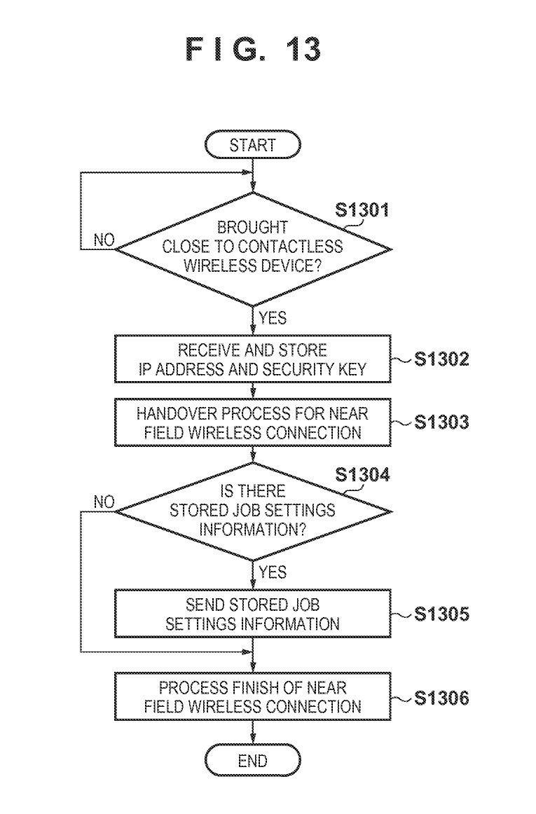

FIG. 13 is a flowchart for describing processing in which, after the mobile terminal 10 according to embodiment 2 has obtained an IP address or security key using contactless wireless communication, a switch is made to near field communication and the job settings information is sent. The processing indicated in this flowchart is executed by the CPU 101, which expands into the RAM 102 a program stored in the ROM 103 of the controller 100 of the mobile terminal 10 or in the storage unit 104, then executes the program.

First, at S1301, the CPU 101 determines whether or not the mobile terminal 10 has approached a device that supports contactless wireless communication, that is, whether or not it has been touched to such a device. When it is determined that an approach has occurred, the procedure proceeds to S1302 and the mobile terminal 10 carries out contactless wireless communication with the target device. In embodiment 2, the contactless wireless communication is NFC communication. The establishment of NFC communication in embodiment 2 is as described with reference to the foregoing FIG. 12. At S1302, an IP address and security key is obtained from the image forming apparatus 20 through S1202 and S1203 of FIG. 12, and these are stored in the RAM 103 or the like. Next, the procedure proceeds to S1303 and the CPU 101 uses the IP address or security key obtained at S1302 in a same manner as S1204 in FIG. 12 to carry out a handover request to the image forming apparatus 20, then a Wi-Fi connection is established with the image forming apparatus 20. In this manner, the procedure proceeds to S1304 after the Wi-Fi connection has been established.

At S1304 the CPU 101 determines whether or not job settings information is recorded in the aforementioned storage area. Here, the procedure proceeds to S1305 when it is stored, and proceeds to S1306 if this is not the case. At S1305 the CPU 101 sends the job settings information that is saved in the storage area to the image forming apparatus 20 via the near field communication unit 11, and the procedure proceeds to S1306. At S1306 the CPU 101 carries out a Wi-Fi communication finishing process, thereby finishing this process.

By executing the foregoing processing in a same manner as embodiment 1, the job settings information saved in the storage area of the mobile terminal 10 can be sent to and set in the image forming apparatus merely by touching the mobile terminal 10 to the image forming apparatus.

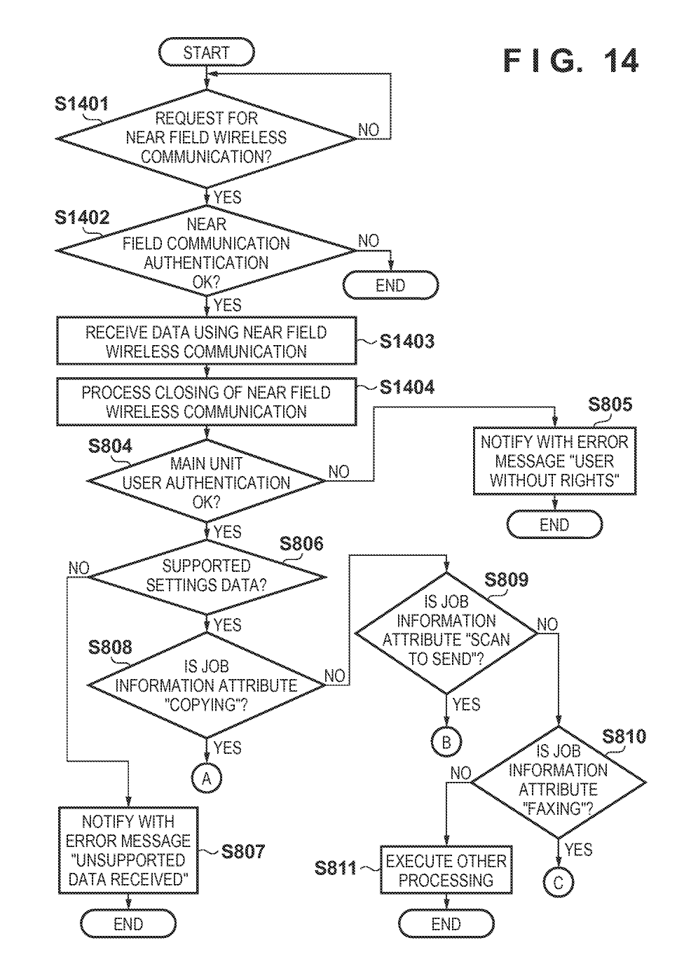

FIG. 14 is a flowchart for describing processing in which the image forming apparatus 20 according to embodiment 2 establishes contactless wireless communication and receives job settings information, then executes the job. The processing indicated in this flowchart is achieved by having the CPU 201 expand a program stored in the ROM 203 or in the storage unit 204 of the controller 200 of the image forming apparatus 20 into the RAM 202, then executing the program. In regard to activation of the NFC tag for the handover and the sending of the IP address and security key, these are activated automatically according to the radio wave emitted by the contactless wireless communication unit 12 of the mobile terminal 10, and therefore are not included in the processing of this flowchart.

First, at S1401 the CPU 201 determines whether or not there is a Wi-Fi connection request from an external device having a Wi-Fi interface. Here, the external device is assumed to be the mobile terminal 10. The procedure proceeds to S1402 in a case where there is a Wi-Fi connection request, and the CPU 201 determines whether or not connection qualifications are present by checking the IP address and security key. Processing proceeds to S1403 in a case where a connection authentication has been carried out at S1402, and in a case where a connection authentication has not been carried out, this process finishes.

At S1403, the CPU 201 establishes a connection with the mobile terminal 10 using near field communication, then receives data via the contactless wireless communication unit 21 and the contactless wireless controller 209, and this data is stored in the RAM 202. When data reception using near field communication is finished in this manner, a closing process of Wi-Fi communication is carried out at S1404. Then, processing from this point onward is the same as the processing indicated by the flowcharts of the foregoing FIG. 8 to FIG. 11 regardless of the communication with the external device, and therefore description of these processes is omitted with the reference numbers being the same as in FIG. 8.

According to embodiment 2 as described above, even in an image forming apparatus in which costs are suppressed by substituting an NFC tag rather than using an NFC reader/writer, by implementing a handover function, the same processing can be achieved in essence as in the foregoing embodiment 1.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-240258, filed Nov. 20, 2013, which is hereby incorporated by reference herein in its entirety.

What is claimed is:

1. A mobile terminal including a contactless-type wireless communication unit, comprising:
a setting unit configured to perform setting of setting information of a function to be executed by a target device,
a storage unit configured to store the setting information set by the setting unit, and
a control unit configured to perform control such that the setting information stored in the storage unit is sent to the target device by the contactless-type wireless communication unit.

2. The mobile terminal according to claim 1,
wherein the control unit performs control such that the setting information stored in the storage unit is sent to the target device by the contactless-type wireless communication unit in a case where the mobile terminal is touched to the target device.

3. A mobile terminal including a contactless-type wireless communication unit and a near field communication unit, comprising:
a setting unit configured to perform setting of setting information of a function to be executed by a target device,
a storage unit configured to store the setting information set by the setting unit,
an activation unit configured to activate a contactless-type wireless communication unit of the target device using the contactless-type wireless communication unit of the mobile terminal, and
a control unit configured to perform control such that the setting information stored in the storage unit is sent to the target device by the near field communication unit, after switching to a communication in which the near field communication unit is used in response to a response from the contactless-type wireless communication unit of the target device activated by the activation unit.

4. The mobile terminal according to claim 1,
wherein the setting information includes information that instructs setting of the setting information or information that instructs execution of the function based on the setting information.

5. The mobile terminal according to claim 1,
wherein the contactless-type wireless communication unit performs communication using a contactless-type wireless communication standard of one of NFC reader/writer, NFC tag, FeliCa, and MIFARE.

6. The mobile terminal according to claim 1, wherein the setting unit executes a cooperative application on the mobile terminal to perform setting.

7. The mobile terminal according to claim 1,
wherein the target device is an image forming apparatus, and the function includes at least one of copying, scanning to send, faxing, and storage.

8. The mobile terminal according to claim 1,
wherein the setting information includes model information of the target device selected by a cooperative application.

9. The mobile terminal according to claim 1,
wherein the setting information includes identification information that is unique to the mobile terminal.

10. The mobile terminal according to claim 1,
wherein, in a case where the storage unit stores setting information including model information of the target device, the setting unit overwrites the setting information stored in the storage unit with the settings information set by the settings unit.

11. The mobile terminal according to claim 1,
wherein the storage unit stores setting information of mutually different models in parallel.

12. An image forming apparatus including a contactless-type wireless communication unit, comprising:
a reception unit configured to receive, in a case where a mobile terminal having a contactless-type wireless communication unit is close, setting information of a function of the image forming apparatus from the mobile terminal,
a setting changing unit configured to change a setting of the function in accordance with the setting information received by the reception unit, and
a control unit configured to perform control such that, in a case where execution of the function is instructed, the function is executed in accordance with the setting changed by the setting changing unit.

13. The image forming apparatus according to claim 12,
further comprising an authentication unit configured to perform authentication of a user of the mobile terminal in a case where the mobile terminal is close,
wherein the setting changing unit changes the setting of the function in a case where the authentication unit has succeeded in authentication of the user.

14. The image forming apparatus according to claim 12,
wherein the control unit performs control such that the function is executed in a case where the setting information includes information instructing execution of the function based on the setting information.

15. A control method for controlling a mobile terminal including a contactless-type wireless communication unit, comprising:
a settings step of performing settings of setting information of a function to be executed by a target device,
a storage step of storing in a memory the setting information set in the setting step, and
a control step of performing control such that the setting information stored in the memory is sent to the target device by the contactless-type wireless communication unit.

16. A control method for controlling a mobile terminal including a contactless-type wireless communication unit and a near field communication unit, comprising:
a setting step of performing setting of setting information of a function to be executed by a target device,
a storage step of storing in a memory the setting information set in the setting step,
an activation step of activating a contactless-type wireless communication unit of the target device using the contactless-type wireless communication unit of the mobile terminal, and
a control step of performing control such that the setting information stored in the memory is sent to the target device by the near field communication unit, after switching to a communication in which the near field communication unit is used in response to a response from the contactless-type wireless communication unit of the target device activated in the activation step.

17. A control method for controlling an image forming apparatus including a contactless-type wireless communication unit, comprising:
a reception step of receiving, in a case where a mobile terminal having a contactless-type wireless communication unit is close, setting information of a function of the image forming apparatus from the mobile terminal,
a setting changing step of changing a setting of the function in accordance with the setting information received in the reception step, and
a control step of performing control such that, in a case where execution of the function is instructed, the function is executed in accordance with the setting changed in the settings changing step.

18. A non-transitory computer-readable storage medium storing a program for causing a computer to execute the steps of, the program being for performing control of a mobile terminal including a contactless-type wireless communication unit,
a setting step of performing setting of setting information of a function to be executed by a target device,
a storage step of storing in a memory the setting information set in the setting step, and
a control step of performing control such that the setting information stored in the memory is sent to the target device by the contactless-type wireless communication unit.

19. A non-transitory computer-readable storage medium storing a program for causing a computer to execute the steps of, the program being for performing control of a mobile terminal including a contactless-type wireless communication unit and a near field communication unit,
a setting step of performing setting of setting information of a function to be executed by a target device,
a storage step of storing in a memory the setting information set in the setting step,
an activation step of activating a contactless-type wireless communication unit of the target device using the contactless-type wireless communication unit of the mobile terminal, and
a control step of performing control such that the setting information stored in the memory is sent to the target device by the near field communication unit, after switching to a communication in which the near field communication unit is used in response to a response from the contactless-type wireless communication unit of the target device activated in the activation step.

20. A non-transitory computer-readable storage medium storing a program for causing a computer to execute the steps of, the program being for performing control of an image forming apparatus including a contactless-type wireless communication unit,
a reception step of receiving, in a case where a mobile terminal having a contactless-type wireless communication unit is close, setting information of a function of the image forming apparatus from the mobile terminal,
a setting changing step of changing a setting of the function in accordance with the setting information received in the reception step, and
a control step of performing control such that, in a case where execution of the function is instructed, the function is executed in accordance with the setting changed in the settings changing step.
